(19) United States
(12) Patent Application Publication
(10) Pub. No.: US 2013/0273600 A1
(43) Pub. Date: Oct. 17, 2013

(54) Stain for Microscopic Tissue Sections

(71) Applicant: Khan Hassan, Mountlake Terrace, WA (US)

(72) Inventor: Khan Hassan, Mountlake Terrace, WA (US)

(21) Appl. No.: 13/447,471

(22) Filed: Apr. 16, 2012

(51) Int. Cl. G01N 1/30

(52) U.S. Cl. 435/40.52

(57) ABSTRACT

Acer rubrum (red maple) foliage may obtain a deep scarlet color. Crocus vernus may display deep purple petals and yellow pistils. Stains from each of these may be extracted by processing targeted portions. One technique is to harvest the material, rinse the harvested material in water, immerse in 70% isopropyl alcohol until the alcohol leaches color out of the material, filter a liquid portion, dehydrate, and re-dissolve in 20% isopropyl alcohol. This extract may then be used to stain tissue.

### FIELD

This disclosure relates to processing and using stain for microscopic tissue sections.

### BACKGROUND

Stains have been used to improve the visibility of features of cells for centuries. Robert Hook identified cells in 1665, and Joseph von Gerlach successfully dyed cells in the 1850s. The use of stains allows greater discrimination between various components of the cell and intercellular structures, and different stains may highlight different features of the tissues.

### SUMMARY

Acer rubrum (red maple) foliage may obtain a deep scarlet color. Crocus vernus may display deep purple petals and yellow pistils. Stains from each of these may be extracted by processing targeted portions. One technique is to harvest the material, rinse the harvested material in water, immerse in 70% isopropyl alcohol until the alcohol leaches color out of the material, filter a liquid portion, dehydrate, and re-dissolve in 20% isopropyl alcohol. This extract may then be used to stain tissue sections.

### BRIEF DESCRIPTION OF THE DRAWINGS

FIG. 1 is a digital image of a tissue section stained by an extract obtained from Acer rubrum in conjunction with hemotoxylin.

FIG. 2 is a digital image of a tissue section stained by an extract obtained from Acer rubrum in conjunction with mucicarmine and hematoxylin.

FIG. 3 is a digital image of fractionated extracts examined under white light.

FIG. 4 is a digital image of fractionated extracts examined under UV light.

FIG. 5 is a digital image of extracts fractionated after DNase and RNase digestion.

FIG. 6 is a flow chart showing one possible technique to obtain stains from Acer rubrum or Crocus vernus.

### DESCRIPTION

Some plants, such as Acer rubrum (red maple) and Crocus vernus, may display deep colors. Stains from each of these may be extracted by processing targeted portions; leaves from Acer rubrum , and petals from Crocus vernus. The instant application discloses stains available from these plants and a technique to obtain the stains.

Color changes in foliage may be caused by a degradation of chlorophyll, which may allow pigments present in the foliage, such as carotenoids and flavonoids, to become visible. Before leaves fall off of a plant, they may become rich in these compounds and display particular colors. In one embodiment of Stain for Microscopic Tissue Sections, leaves from Acer rubrum, which may display a red color, may be used. In another embodiment, petals from Crocus vernus, which may display deep purple coloration, may be used. These materials may be processed to provide one or more Stains for Microscopic Tissue Sections.

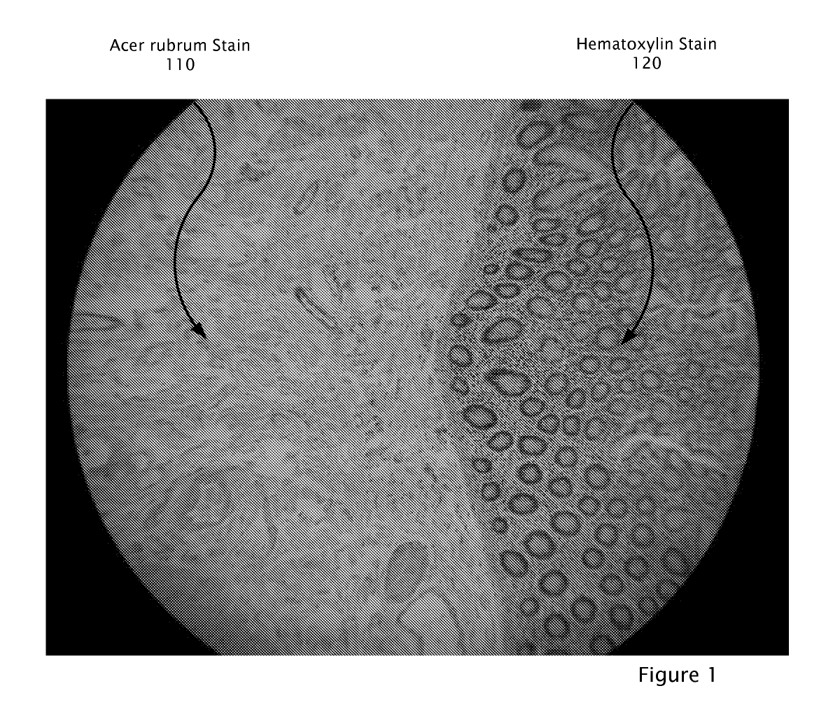

FIG. 1 is a digital image of a tissue section stained by an extract obtained from Acer rubrum in conjunction with hemotoxylin. Acer rubrum Stain 110 may be obtained from Acer rubrum, and may stain cytoplasmic and intercellular structures, as in this example, a brown-yellow color. Hemotoxylin Stain 120 may stain nuclear components of the cell a darker brown. The image shown is a section from a human colon. In this image, it may be seen that E1 stained connective tissue components, but did not stain adipose tissues.

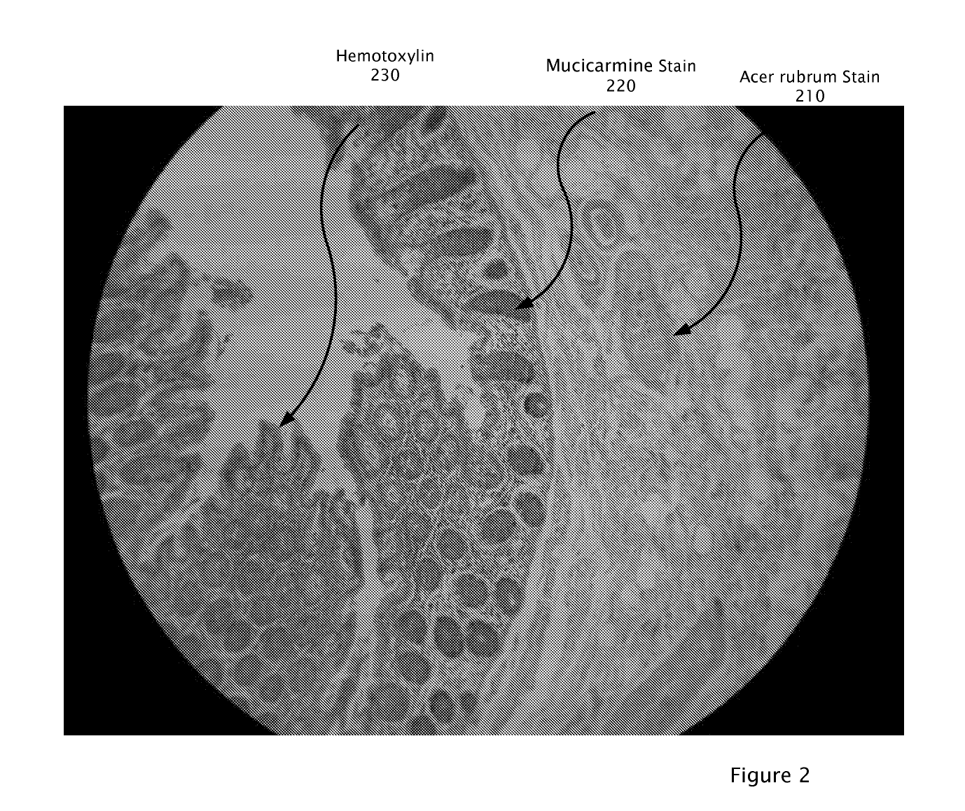

FIG. 2 is a digital image of a tissue section stained by an extract obtained from Acer rubrum in conjunction with mucicarmine and hematoxylin. The Acer rubrum Stain 210 may be seen as a brownish-yellow, similar to FIG. 1, while Mucicarmine Stain 220 appears reddish, and Hemotoxylin Stain 230 appears dark brown.

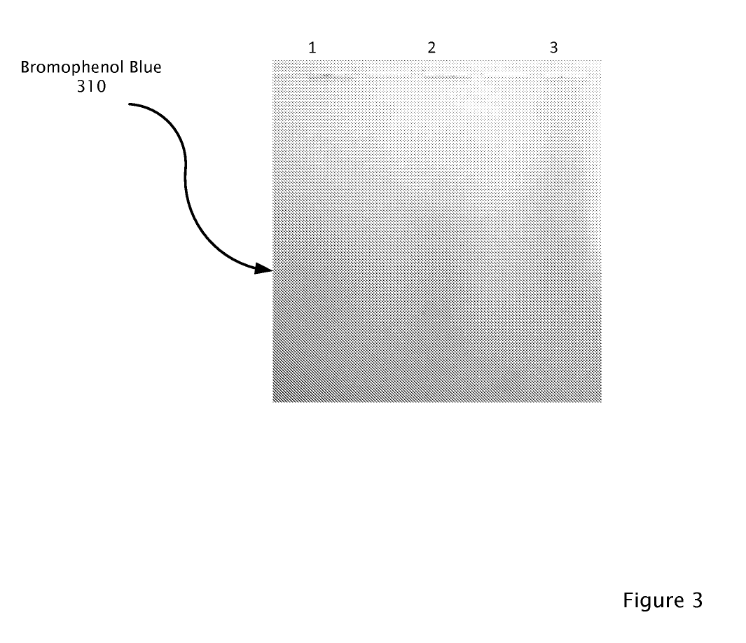

FIG. 3 is a digital image of fractionated extracts examined under white light. In this example, extracts were fractionated in one 1% agarose gel using standard procedures. The gel was examined under white light. Lane assignments: 1. Bromophenol blue, 2. E1 , 3. E4.

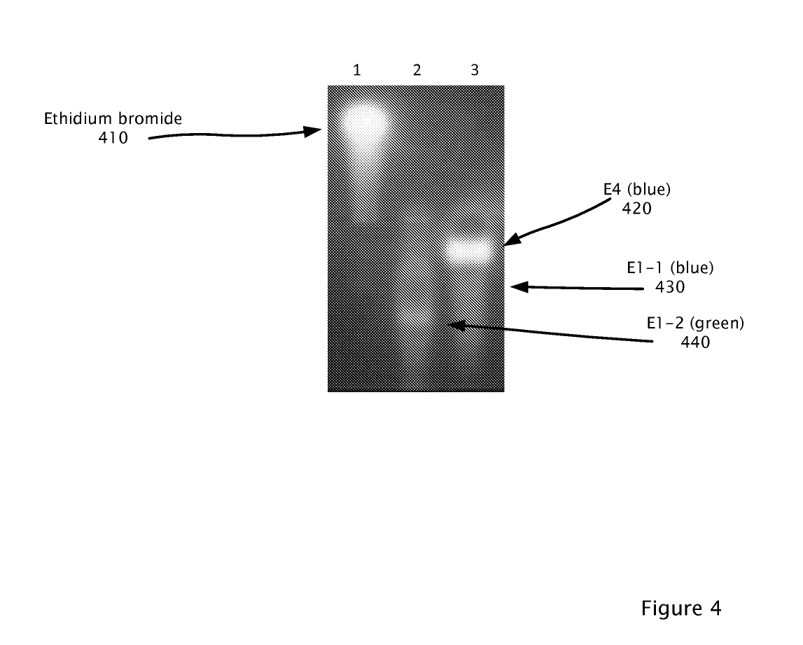

FIG. 4 is a digital image of fractionated extracts examined under UV light. The same gel was examined under UV light with ethidium bromide in lane 1. E1 shows two bands, E1-1 (blue) 430, and E1-2 (green) 440 appear to be discrete molecules forming a band in gel electrophoresis, indicating homogeneous formation. E4 (blue) 420 is also UV excitable.

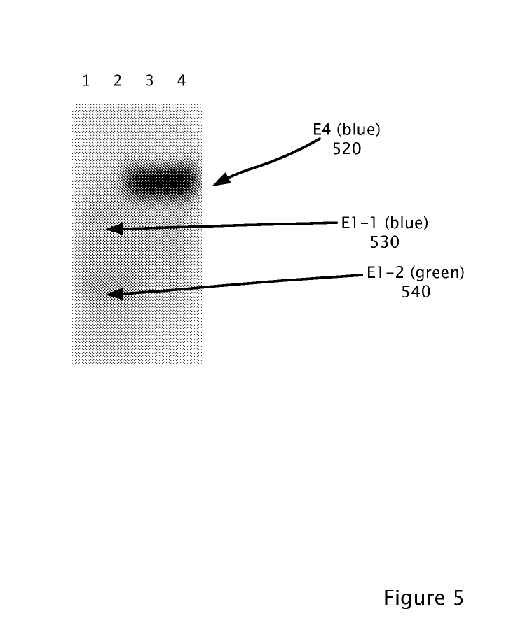

FIG. 5 is a digital image of extracts fractionated after deoxyribonuclease (DNase) and ribonuclease (RNase) digestion. Extracts were digested DNase and RNase respectively and fractionated in 1% agarose gel using standard procedures and examined under UV light. Lane assignments: 1. E1: DNase digested, 2. E1: RNase digested, 3. E4 Dnase digested, 4. E4 RNase digested.

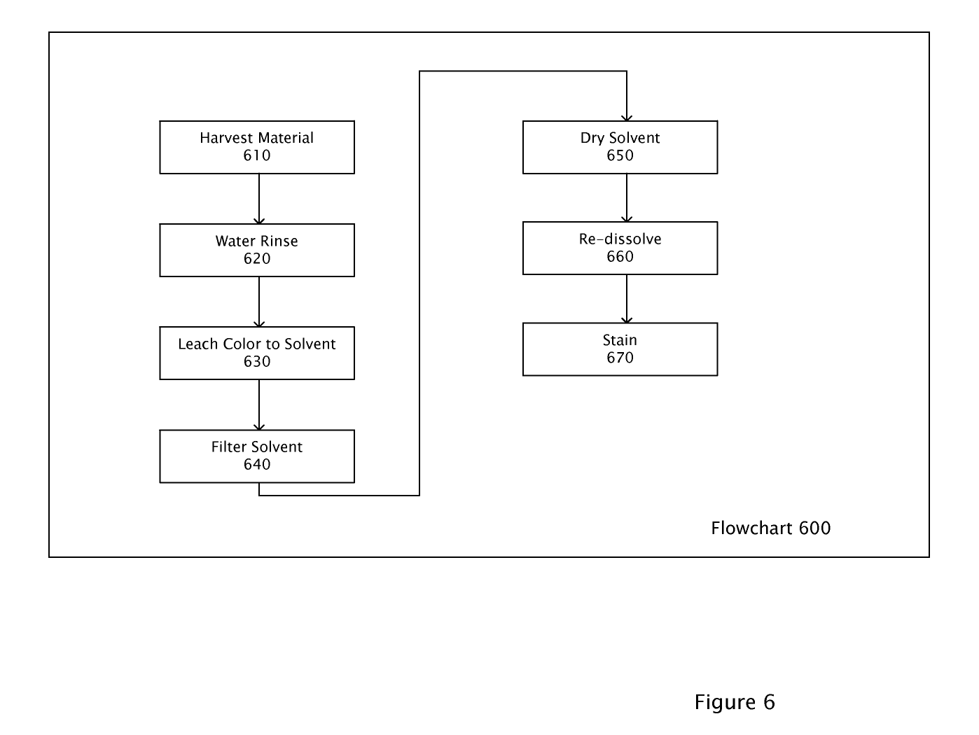

FIG. 6 is a flow chart showing one possible technique to obtain stains from Acer rubrum or Crocus vernus. Leaves of Acer rubrum may be may be Harvested 610 after a change of color but before apoptosis. Leaves and petals of Crocus vernus may also be Harvested 610. Other materials may also be Harvested 610 and processed to obtain a stain. After Harvesting 610, the harvested material may be gently Water Rinsed 620 to clean remove any surface contaminants that may be present.

The harvested material may be Leached 630 in a solvent comprising approximately 70% isopropanol until the solvent obtains a color. This may be done by storing solvent soaking the material in a dark container at approximately ambient temperature for approximately five to seven days.

The solvent may be Filtered 640 to remove any particulate matter, and an extract may be obtained by Drying the Solvent 650. Drying the Solvent 650 may be done by air drying at or near ambient temperature, or by using a low power on a heat fan.

The extract may be re-dissolved in 10% to 20% isopropanol, which may provide a stain suitable, for example, for staining tissue samples to study using a microscope.

One having skill in the art will recognize that other materials or combinations of materials may be used in addition or as an alternative to Acer rubrum leaves or Crocus vernus petals and leaves to obtain stains.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A stain to enhance contrast on a microscopic tissue sample obtained by a process comprising:
harvesting a material from which to extract the stain;
rinsing the material with water;
soaking the material in a solvent comprising 60% to 80% isopropanol until the solvent obtains a color;
filtering the solvent to remove any particulate matter;
drying the solvent;
obtaining an extract; and
dissolving the extract in 10% to 20% isopropanol.

2. The stain of claim 1 wherein the material comprises Acer rubrum leaves harvested after a change of color before apoptosis.

3. The stain of claim 1 wherein the material comprises Crocus vermus leaves and petals.

4. The stain of claim 1 wherein drying the solvent comprises air drying the solvent at ambient temperature.

5. The stain of claim 1 wherein drying the solvent comprises air drying the solvent at a temperature between ambient temperature and twenty degrees Celsius above ambient temperature.

6. A method comprising:
harvesting a material from which to extract the stain;
rinsing the material with water;
soaking the material in a solvent comprising 60% to 80% isopropanol until the solvent obtains a color;
filtering the solvent to remove any particulate matter;
drying the solvent;
obtaining an extract; and
dissolving the extract in 10% to 20% isopropanol.

7. The method of claim 6 wherein drying the solvent comprises air drying the solvent at ambient temperature.

8. The stain of claim 6 wherein drying the solvent comprises air drying the solvent at a temperature between ambient temperature and twenty degrees Celsius above ambient temperature.
